(19) United States
(12) Patent Application Publication
(10) Pub. No.: US 2025/0014011 A1
(43) Pub. Date: Jan. 9, 2025

(54) Method, System, and Computer Program Product for Controlling Issuer Transactions

(71) Applicant: Visa International Service Association, San Francisco, CA (US)

(72) Inventors: Ratna Deepthi Jarugu, Sunnyvale, CA (US); Libby A. Kurien, Santa Clara, CA (US); Sonia Gupta, Pleasanton, CA (US); William M. Boyce, Menlo Park, CA (US); Zhi Yong Chen, London (GB)

(21) Appl. No.: 18/762,822

(22) Filed: Jul. 3, 2024

Related U.S. Application Data
(60) Provisional application No. 63/512,393, filed on Jul. 7, 2023.

(51) Int. Cl. G06Q 20/28; G06Q 20/40

(52) U.S. Cl. CPC G06Q 20/28; G06Q 20/40

(57) ABSTRACT

A method includes: controlling a prefunded account of an issuer system by a transaction processing system; receiving first transaction requests associated with first transactions initiated by first payment devices issued by the issuer system; for each first transaction: determining that the issuer system issued a corresponding first payment device; determining an accumulated authorization amount; determining that the accumulated authorization amount does not satisfy a threshold based on the prefunded amount; and generating and communicating an authorization request associated with the corresponding first transaction to the issuer system; receiving a second transaction request associated with a second transaction initiated by a second payment device issued by the issuer system; in response to receiving the second transaction request, determining that the issuer system issued the second payment device; determining an updated accumulated authorization amount; determining that the updated accumulated authorization amount satisfies the threshold; and automatically declining the second transaction.

### CROSS-REFERENCE TO RELATED APPLICATION

This application claims the benefit of U.S. Provisional Application No. 63/512,393, filed Jul. 7, 2023, the disclosure of which is hereby incorporated by reference in its entirety.

### BACKGROUND

### 1. Technical Field

This disclosure relates generally to controlling transactions and, in some non-limiting embodiments or aspects, to methods, systems, and computer program products for controlling issuer transactions.

### 2. Technical Considerations

Issuer systems engage with transaction processing systems to enable users to whom those issuer systems have issued payment devices to initiate electronic payment transactions at various merchants. However, a transaction processing system enabling an issuer system to use its payment network to process electronic payment transactions with its issued payment devices exposes the transaction service provider to risk for the transaction amounts of transactions authorized by the issuer system, for example, in the event of the issuer defaulting. This is due to existing transaction processing systems being incapable of monitoring and controlling issuer transactions relative to the capacity of the issuer system. Thus, existing systems involve the transaction processing system requiring the issuer system to post significant collateral before enabling the issuer system to process its transactions over the payment network.

### SUMMARY

Accordingly, provided are improved methods, systems, and computer program products for controlling issuer transactions.

According to non-limiting embodiments or aspects, provided is a computer-implemented method including: controlling a prefunded account of an issuer system by a transaction processing system, the prefunded account containing a prefunded amount; processing, with at least one processor of the transaction processing system, a plurality of electronic payment transactions initiated by a plurality of users using a plurality of payment devices issued by the issuer system by: sequentially receiving, from a plurality of first merchant systems, a plurality of first transaction request messages associated with a plurality of first transactions initiated by a plurality of first payment devices of the plurality of payment devices issued by the issuer system, each first transaction of the plurality of first transactions having an associated first transaction amount; for each first transaction of the plurality of first transactions: in response to receiving the first transaction request message, determining that the issuer system issued a corresponding first payment device based on transaction data contained in the first transaction request message; determining an accumulated authorization amount based on preceding transaction amounts of the plurality of first transactions that have been authorized and the corresponding first transaction amount; determining that the accumulated authorization amount does not satisfy a threshold based on the prefunded amount; and in response to determining that the accumulated authorization amount does not satisfy the threshold, generating and communicating an authorization request message associated with the corresponding first transaction to the issuer system; receiving, from a second merchant system, a second transaction request message associated with a second transaction initiated by a second payment device of the plurality of payment devices issued by the issuer system, the second transaction having an associated second transaction amount; in response to receiving the second transaction request message, determining that the issuer system issued the second payment device based on transaction data contained in the second transaction request message; determining an updated accumulated authorization amount based on the accumulated authorization amount and the second transaction amount; determining that the updated accumulated authorization amount satisfies the threshold; and in response to determining that the updated accumulated authorization amount satisfies the threshold, automatically declining the second transaction.

In some non-limiting embodiments or aspects, the transaction processing system may be configured to transfer funds from the prefunded account, but the issuer system may not be configured to transfer funds from the prefunded account.

In some non-limiting embodiments or aspects, the issuer system may transfer additional funds to the prefunded account, and the computer-implemented method may further include: in response to the issuer system transferring the additional funds to the prefunded account, updating a balance in the prefunded account based on the additional funds.

In some non-limiting embodiments or aspects, the method may further include receiving, by the transaction processing system, a webhook notification in response to the issuer system transferring the additional funds to the prefunded account.

In some non-limiting embodiments or aspects, the issuer system may transfer the additional funds to the prefunded account during processing of at least one of the plurality of first transactions.

In some non-limiting embodiments or aspects, controlling the prefunded account may include configuring the transaction processing system to transfer at least a portion of the prefunded amount from the prefunded account.

In some non-limiting embodiments or aspects, the method may further include, during settlement of a transaction of the plurality of first transactions, automatically transferring, by the transaction processing system, at least a portion of the first transaction amount corresponding to the transaction from the prefunded account to an account of the first merchant system corresponding to the transaction.

In some non-limiting embodiments or aspects, the automatic transfer may be executed in response to a default message associated with the issuer system.

According to non-limiting embodiments or aspects, provided is a system including at least one processor of a transaction processing system, the at least one processor configured to: control a prefunded account of an issuer system by the transaction processing system, the prefunded account containing a prefunded amount; process a plurality of electronic payment transactions initiated by a plurality of users using a plurality of payment devices issued by the issuer system by: sequentially receiving, from a plurality of first merchant systems, a plurality of first transaction request messages associated with a plurality of first transactions initiated by a plurality of first payment devices of the plurality of payment devices issued by the issuer system, each first transaction of the plurality of first transactions having an associated first transaction amount; for each first transaction of the plurality of first transactions: in response to receiving the first transaction request message, determining that the issuer system issued a corresponding first payment device based on transaction data contained in the first transaction request message; determining an accumulated authorization amount based on preceding transaction amounts of the plurality of first transactions that have been authorized and the corresponding first transaction amount; determining that the accumulated authorization amount does not satisfy a threshold based on the prefunded amount; and in response to determining that the accumulated authorization amount does not satisfy the threshold, generating and communicating an authorization request message associated with the corresponding first transaction to the issuer system; receiving, from a second merchant system, a second transaction request message associated with a second transaction initiated by a second payment device of the plurality of payment devices issued by the issuer system, the second transaction having an associated second transaction amount; in response to receiving the second transaction request message, determining that the issuer system issued the second payment device based on transaction data contained in the second transaction request message; determining an updated accumulated authorization amount based on the accumulated authorization amount and the second transaction amount; determining that the updated accumulated authorization amount satisfies the threshold; and in response to determining that the updated accumulated authorization amount satisfies the threshold, automatically declining the second transaction.

In some non-limiting embodiments or aspects, the transaction processing system may be configured to transfer funds from the prefunded account, but the issuer system may not be configured to transfer funds from the prefunded account.

In some non-limiting embodiments or aspects, the issuer system may transfer additional funds to the prefunded account, and the at least one processor may be configured to: in response to the issuer system transferring the additional funds to the prefunded account, update a balance in the prefunded account based on the additional funds.

In some non-limiting embodiments or aspects, the at least one processor may be configured to: receive a webhook notification in response to the issuer system transferring the additional funds to the prefunded account.

In some non-limiting embodiments or aspects, the issuer system may transfer the additional funds to the prefunded account during processing of at least one of the plurality of first transactions.

In some non-limiting embodiments or aspects, controlling the prefunded account may include configuring the transaction processing system to transfer at least a portion of the prefunded amount from the prefunded account.

In some non-limiting embodiments or aspects, the at least one processor may be configured to: during settlement of a transaction of the plurality of first transactions, automatically transfer at least a portion of the first transaction amount corresponding to the transaction from the prefunded account to an account of the first merchant system corresponding to the transaction.

In some non-limiting embodiments or aspects, the automatic transfer may be executed in response to a default message associated with the issuer system.

According to non-limiting embodiments or aspects, provided is a computer program product including at least one non-transitory computer-readable medium including program instructions that, when executed by at least one processor, cause the at least one processor of a transaction processing system to: control a prefunded account of an issuer system by the transaction processing system, the prefunded account containing a prefunded amount; process a plurality of electronic payment transactions initiated by a plurality of users using a plurality of payment devices issued by the issuer system by: sequentially receiving, from a plurality of first merchant systems, a plurality of first transaction request messages associated with a plurality of first transactions initiated by a plurality of first payment devices of the plurality of payment devices issued by the issuer system, each first transaction of the plurality of first transactions having an associated first transaction amount; for each first transaction of the plurality of first transactions: in response to receiving the first transaction request message, determining that the issuer system issued a corresponding first payment device based on transaction data contained in the first transaction request message; determining an accumulated authorization amount based on preceding transaction amounts of the plurality of first transactions that have been authorized and the corresponding first transaction amount; determining that the accumulated authorization amount does not satisfy a threshold based on the prefunded amount; and in response to determining that the accumulated authorization amount does not satisfy the threshold, generating and communicating an authorization request message associated with the corresponding first transaction to the issuer system; receiving, from a second merchant system, a second transaction request message associated with a second transaction initiated by a second payment device of the plurality of payment devices issued by the issuer system, the second transaction having an associated second transaction amount; in response to receiving the second transaction request message, determining that the issuer system issued the second payment device based on transaction data contained in the second transaction request message; determining an updated accumulated authorization amount based on the accumulated authorization amount and the second transaction amount; determining that the updated accumulated authorization amount satisfies the threshold; and in response to determining that the updated accumulated authorization amount satisfies the threshold, automatically declining the second transaction.

In some non-limiting embodiments or aspects, the transaction processing system may be configured to transfer funds from the prefunded account, but the issuer system may not be configured to transfer funds from the prefunded account.

In some non-limiting embodiments or aspects, the issuer system may transfer additional funds to the prefunded account, and the instructions may cause the at least one processor to: in response to the issuer system transferring the additional funds to the prefunded account, update a balance in the prefunded account based on the additional funds.

In some non-limiting embodiments or aspects, the instructions may cause the at least one processor to: receive a webhook notification in response to the issuer system transferring the additional funds to the prefunded account.

In some non-limiting embodiments or aspects, the issuer system may transfer the additional funds to the prefunded account during processing of at least one of the plurality of first transactions.

In some non-limiting embodiments or aspects, controlling the prefunded account may include configuring the transaction processing system to transfer at least a portion of the prefunded amount from the prefunded account.

In some non-limiting embodiments or aspects, the instructions may cause the at least one processor to: during settlement of a transaction of the plurality of first transactions, automatically transfer at least a portion of the first transaction amount corresponding to the transaction from the prefunded account to an account of the first merchant system corresponding to the transaction.

In some non-limiting embodiments or aspects, the automatic transfer may be executed in response to a default message associated with the issuer system.

Further non-limiting embodiments or aspects will be set forth in the following numbered clauses:

Clause 1: A computer-implemented method comprising: controlling a prefunded account of an issuer system by a transaction processing system, the prefunded account containing a prefunded amount; processing, with at least one processor of the transaction processing system, a plurality of electronic payment transactions initiated by a plurality of users using a plurality of payment devices issued by the issuer system by: sequentially receiving, from a plurality of first merchant systems, a plurality of first transaction request messages associated with a plurality of first transactions initiated by a plurality of first payment devices of the plurality of payment devices issued by the issuer system, each first transaction of the plurality of first transactions having an associated first transaction amount; for each first transaction of the plurality of first transactions: in response to receiving the first transaction request message, determining that the issuer system issued a corresponding first payment device based on transaction data contained in the first transaction request message; determining an accumulated authorization amount based on preceding transaction amounts of the plurality of first transactions that have been authorized and the corresponding first transaction amount; determining that the accumulated authorization amount does not satisfy a threshold based on the prefunded amount; and in response to determining that the accumulated authorization amount does not satisfy the threshold, generating and communicating an authorization request message associated with the corresponding first transaction to the issuer system; receiving, from a second merchant system, a second transaction request message associated with a second transaction initiated by a second payment device of the plurality of payment devices issued by the issuer system, the second transaction having an associated second transaction amount; in response to receiving the second transaction request message, determining that the issuer system issued the second payment device based on transaction data contained in the second transaction request message; determining an updated accumulated authorization amount based on the accumulated authorization amount and the second transaction amount; determining that the updated accumulated authorization amount satisfies the threshold; and in response to determining that the updated accumulated authorization amount satisfies the threshold, automatically declining the second transaction.

Clause 2: The computer-implemented method of clause 1, wherein the transaction processing system is configured to transfer funds from the prefunded account, but the issuer system is not configured to transfer funds from the prefunded account.

Clause 3: The computer-implemented method of clause 1 or 2, wherein the issuer system transfers additional funds to the prefunded account, the computer-implemented method further comprising: in response to the issuer system transferring the additional funds to the prefunded account, updating a balance in the prefunded account based on the additional funds.

Clause 4: The computer-implemented method of any of clauses 1-3, further comprising: receiving, by the transaction processing system, a webhook notification in response to the issuer system transferring the additional funds to the prefunded account.

Clause 5: The computer-implemented method of any of clauses 1-4, wherein the issuer system transfers the additional funds to the prefunded account during processing of at least one of the plurality of first transactions.

Clause 6: The computer-implemented method of any of clauses 1-5, wherein controlling the prefunded account comprises configuring the transaction processing system to transfer at least a portion of the prefunded amount from the prefunded account.

Clause 7: The computer-implemented method of any of clauses 1-6, further comprising: during settlement of a transaction of the plurality of first transactions, automatically transferring, by the transaction processing system, at least a portion of the first transaction amount corresponding to the transaction from the prefunded account to an account of the first merchant system corresponding to the transaction.

Clause 8: The computer-implemented method of any of clauses 1-7, wherein the automatic transfer is executed in response to a default message associated with the issuer system.

Clause 9: A system comprising at least one processor of a transaction processing system, the at least one processor configured to: control a prefunded account of an issuer system by the transaction processing system, the prefunded account containing a prefunded amount; process a plurality of electronic payment transactions initiated by a plurality of users using a plurality of payment devices issued by the issuer system by: sequentially receiving, from a plurality of first merchant systems, a plurality of first transaction request messages associated with a plurality of first transactions initiated by a plurality of first payment devices of the plurality of payment devices issued by the issuer system, each first transaction of the plurality of first transactions having an associated first transaction amount; for each first transaction of the plurality of first transactions: in response to receiving the first transaction request message, determining that the issuer system issued a corresponding first payment device based on transaction data contained in the first transaction request message; determining an accumulated authorization amount based on preceding transaction amounts of the plurality of first transactions that have been authorized and the corresponding first transaction amount; determining that the accumulated authorization amount does not satisfy a threshold based on the prefunded amount; and in response to determining that the accumulated authorization amount does not satisfy the threshold, generating and communicating an authorization request message associated with the corresponding first transaction to the issuer system; receiving, from a second merchant system, a second transaction request message associated with a second transaction initiated by a second payment device of the plurality of payment devices issued by the issuer system, the second transaction having an associated second transaction amount; in response to receiving the second transaction request message, determining that the issuer system issued the second payment device based on transaction data contained in the second transaction request message; determining an updated accumulated authorization amount based on the accumulated authorization amount and the second transaction amount; determining that the updated accumulated authorization amount satisfies the threshold; and in response to determining that the updated accumulated authorization amount satisfies the threshold, automatically declining the second transaction.

Clause 10: The system of clause 9, wherein the transaction processing system is configured to transfer funds from the prefunded account, but the issuer system is not configured to transfer funds from the prefunded account.

Clause 11: The system of clause 9 or 10, wherein the issuer system transfers additional funds to the prefunded account, the at least one processor configured to: in response to the issuer system transferring the additional funds to the prefunded account, update a balance in the prefunded account based on the additional funds.

Clause 12: The system of any of clauses 9-11, the at least one processor configured to: receive a webhook notification in response to the issuer system transferring the additional funds to the prefunded account.

Clause 13: The system of any of clauses 9-12, wherein the issuer system transfers the additional funds to the prefunded account during processing of at least one of the plurality of first transactions.

Clause 14: The system of any of clauses 9-13, wherein controlling the prefunded account comprises configuring the transaction processing system to transfer at least a portion of the prefunded amount from the prefunded account.

Clause 15: The system of any of clauses 9-14, the at least one processor configured to: during settlement of a transaction of the plurality of first transactions, automatically transfer at least a portion of the first transaction amount corresponding to the transaction from the prefunded account to an account of the first merchant system corresponding to the transaction.

Clause 16: The system of any of clauses 9-15, wherein the automatic transfer is executed in response to a default message associated with the issuer system.

Clause 17: A computer program product comprising at least one non-transitory computer-readable medium including program instructions that, when executed by at least one processor, cause the at least one processor of a transaction processing system to: control a prefunded account of an issuer system by the transaction processing system, the prefunded account containing a prefunded amount; process a plurality of electronic payment transactions initiated by a plurality of users using a plurality of payment devices issued by the issuer system by: sequentially receiving, from a plurality of first merchant systems, a plurality of first transaction request messages associated with a plurality of first transactions initiated by a plurality of first payment devices of the plurality of payment devices issued by the issuer system, each first transaction of the plurality of first transactions having an associated first transaction amount; for each first transaction of the plurality of first transactions: in response to receiving the first transaction request message, determining that the issuer system issued a corresponding first payment device based on transaction data contained in the first transaction request message; determining an accumulated authorization amount based on preceding transaction amounts of the plurality of first transactions that have been authorized and the corresponding first transaction amount; determining that the accumulated authorization amount does not satisfy a threshold based on the prefunded amount; and in response to determining that the accumulated authorization amount does not satisfy the threshold, generating and communicating an authorization request message associated with the corresponding first transaction to the issuer system; receiving, from a second merchant system, a second transaction request message associated with a second transaction initiated by a second payment device of the plurality of payment devices issued by the issuer system, the second transaction having an associated second transaction amount; in response to receiving the second transaction request message, determining that the issuer system issued the second payment device based on transaction data contained in the second transaction request message; determining an updated accumulated authorization amount based on the accumulated authorization amount and the second transaction amount; determining that the updated accumulated authorization amount satisfies the threshold; and in response to determining that the updated accumulated authorization amount satisfies the threshold, automatically declining the second transaction.

Clause 18: The computer program product of clause 17, wherein the transaction processing system is configured to transfer funds from the prefunded account, but the issuer system is not configured to transfer funds from the prefunded account.

Clause 19: The computer program product of clause 17 or 18, wherein the issuer system transfers additional funds to the prefunded account, the instructions cause the at least one processor to: in response to the issuer system transferring the additional funds to the prefunded account, update a balance in the prefunded account based on the additional funds.

Clause 20: The computer program product of any of clauses 17-19, the instructions cause the at least one processor to: receive a webhook notification in response to the issuer system transferring the additional funds to the prefunded account.

Clause 21: The computer program product of any of clauses 17-20, wherein the issuer system transfers the additional funds to the prefunded account during processing of at least one of the plurality of first transactions.

Clause 22: The computer program product of any of clauses 17-21, wherein controlling the prefunded account comprises configuring the transaction processing system to transfer at least a portion of the prefunded amount from the prefunded account.

Clause 23: The computer program product of any of clauses 17-22, the instructions cause the at least one processor to: during settlement of a transaction of the plurality of first transactions, automatically transfer at least a portion of the first transaction amount corresponding to the transaction from the prefunded account to an account of the first merchant system corresponding to the transaction.

Clause 24: The computer program product of any of clauses 17-23, wherein the automatic transfer is executed in response to a default message associated with the issuer system.

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosed subject matter.

### BRIEF DESCRIPTION OF THE DRAWINGS

Additional advantages and details are explained in greater detail below with reference to the non-limiting, exemplary embodiments that are illustrated in the accompanying schematic figures, in which:

FIG. 1 is a schematic diagram of an example system for controlling issuer transactions, according to some non-limiting embodiments or aspects;

FIGS. 2A-2B is a flow diagram of a method for controlling issuer transactions, according to some non-limiting embodiments or aspects;

FIG. 3 is a process flow diagram of an example system for controlling issuer transactions, according to some non-limiting embodiments or aspects;

FIGS. 4A-4B are schematic diagrams of example systems for controlling issuer transactions, according to some non-limiting embodiments or aspects;

FIG. 5 is a schematic diagram of an example system for controlling issuer transactions, according to some non-limiting embodiments or aspects;

FIG. 6 is a schematic diagram of an example electronic payment processing network, according to some non-limiting embodiments or aspects; and

FIG. 7 is a schematic diagram of example components of a device used in connection with some non-limiting embodiments or aspects.

### DETAILED DESCRIPTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the embodiments as they are oriented in the drawing figures. However, it is to be understood that the present disclosure may assume various alternative variations and step sequences, except where expressly specified to the contrary. It is also to be understood that the specific devices and processes illustrated in the attached drawings, and described in the following specification, are simply exemplary and non-limiting embodiments or aspects of the disclosed subject matter. Hence, specific dimensions and other physical characteristics related to the embodiments or aspects disclosed herein are not to be considered as limiting.

Some non-limiting embodiments or aspects are described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, etc.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, and/or the like) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise. In addition, reference to an action being “based on” a condition may refer to the action being “in response to” the condition. For example, the phrases “based on” and “in response to” may, in some non-limiting embodiments or aspects, refer to a condition for automatically triggering an action (e.g., a specific operation of an electronic device, such as a computing device, a processor, and/or the like).

As used herein, the term “acquirer institution” may refer to an entity licensed and/or approved by a transaction service provider to originate transactions (e.g., payment transactions) using a payment device associated with the transaction service provider. The transactions the acquirer institution may originate may include payment transactions (e.g., purchases, original credit transactions (OCTs), account funding transactions (AFTs), and/or the like). In some non-limiting embodiments or aspects, an acquirer institution may be a financial institution, such as a bank. As used herein, the term “acquirer system” may refer to one or more computing devices operated by or on behalf of an acquirer institution, such as a server computer executing one or more software applications.

As used herein, the term “account identifier” may include one or more primary account numbers (PANs), tokens, or other identifiers associated with a customer account. The term “token” may refer to an identifier that is used as a substitute or replacement identifier for an original account identifier, such as a PAN. Account identifiers may be alphanumeric or any combination of characters and/or symbols. Tokens may be associated with a PAN or other original account identifier in one or more data structures (e.g., one or more databases, and/or the like) such that they may be used to conduct a transaction without directly using the original account identifier. In some examples, an original account identifier, such as a PAN, may be associated with a plurality of tokens for different individuals or purposes.

As used herein, the terms “client” and/or “client device” may refer to one or more client-side devices or systems (e.g., remote from a transaction service provider system) used to initiate or facilitate a transaction (e.g., a payment transaction). As an example, a “client device” may refer to one or more POS devices used by a merchant, one or more acquirer host computers used by an acquirer, one or more mobile devices used by a user, and/or the like. In some non-limiting embodiments or aspects, a client device may be an electronic device configured to communicate with one or more networks and initiate or facilitate transactions. For example, a client device may include one or more computers, portable computers, laptop computers, tablet computers, mobile devices, cellular phones, wearable devices (e.g., watches, glasses, lenses, clothing, and/or the like), PDAs, and/or the like. Moreover, a “client” may also refer to an entity (e.g., a merchant, an acquirer, and/or the like) that owns, utilizes, and/or operates a client device for initiating transactions (e.g., for initiating transactions with a transaction service provider).

As used herein, the term “communication” may refer to the reception, receipt, transmission, transfer, provision, and/or the like of data (e.g., information, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection (e.g., a direct communication connection, an indirect communication connection, and/or the like) that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit processes information received from the first unit and communicates the processed information to the second unit. In some non-limiting embodiments or aspects, a message may refer to a network packet (e.g., a data packet and/or the like) that includes data. It will be appreciated that numerous other arrangements are possible.

As used herein, the term “computing device” may refer to one or more electronic devices configured to process data. A computing device may, in some examples, include the necessary components to receive, process, and output data, such as a processor, a display, a memory, an input device, a network interface, and/or the like. A computing device may be a mobile device. As an example, a mobile device may include a cellular phone (e.g., a smartphone or standard cellular phone), a portable computer, a wearable device (e.g., watches, glasses, lenses, clothing, and/or the like), a personal digital assistant (PDA), and/or other like devices. A computing device may also be a desktop computer or other form of non-mobile computer.

As used herein, the terms “electronic wallet” and “electronic wallet application” refer to one or more electronic devices and/or software applications configured to initiate and/or conduct payment transactions. For example, an electronic wallet may include a mobile device executing an electronic wallet application, and may further include server-side software and/or databases for maintaining and providing transaction data to the mobile device. An “electronic wallet provider” may include an entity that provides and/or maintains an electronic wallet for a customer, such as Google Pay®, Android Pay®, Apple Pay®, Samsung Pay®, and/or other like electronic payment systems. In some non-limiting examples, an issuer bank may be an electronic wallet provider.

As used herein, the term “issuer institution” may refer to one or more entities, such as a bank, that provide accounts to customers for conducting transactions (e.g., payment transactions), such as initiating credit and/or debit payments. For example, an issuer institution may provide an account identifier, such as a PAN, to a customer that uniquely identifies one or more accounts associated with that customer. The account identifier may be embodied on a portable financial device, such as a physical financial instrument, e.g., a payment card, and/or may be electronic and used for electronic payments. The term “issuer system” refers to one or more computer devices operated by or on behalf of an issuer institution, such as a server computer executing one or more software applications. For example, an issuer system may include one or more authorization servers for authorizing a transaction.

As used herein, the term “merchant” may refer to an individual or entity that provides goods and/or services, or access to goods and/or services, to customers based on a transaction, such as a payment transaction. The term “merchant” or “merchant system” may also refer to one or more computer systems operated by or on behalf of a merchant, such as a server computer executing one or more software applications.

As used herein, the term “payment device” may refer to an electronic payment device, a portable financial device, a payment card (e.g., a credit or debit card), a gift card, a smartcard, smart media, a payroll card, a healthcare card, a wristband, a machine-readable medium containing account information, a keychain device or fob, an RFID transponder, a retailer discount or loyalty card, a cellular phone, an electronic wallet mobile application, a personal digital assistant (PDA), a pager, a security card, a computing device, an access card, a wireless terminal, a transponder, and/or the like. In some non-limiting embodiments or aspects, the payment device may include volatile or non-volatile memory to store information (e.g., an account identifier, a name of the account holder, and/or the like).

As used herein, the term “payment gateway” may refer to an entity and/or a payment processing system operated by or on behalf of such an entity (e.g., a merchant service provider, a payment service provider, a payment facilitator, a payment facilitator that contracts with an acquirer, a payment aggregator, and/or the like), which provides payment services (e.g., transaction service provider payment services, payment processing services, and/or the like) to one or more merchants. The payment services may be associated with the use of portable financial devices managed by a transaction service provider. As used herein, the term “payment gateway system” may refer to one or more computer systems, computer devices, servers, groups of servers, and/or the like, operated by or on behalf of a payment gateway.

As used herein, a “point-of-sale (POS) device” may refer to one or more devices, which may be used by a merchant to conduct a transaction (e.g., a payment transaction) and/or process a transaction. For example, a POS device may include one or more client devices. Additionally or alternatively, a POS device may include peripheral devices, card readers, scanning devices (e.g., code scanners), Bluetooth® communication receivers, near-field communication (NFC) receivers, radio frequency identification (RFID) receivers, and/or other contactless transceivers or receivers, contact-based receivers, payment terminals, and/or the like. As used herein, a “point-of-sale (POS) system” may refer to one or more client devices and/or peripheral devices used by a merchant to conduct a transaction. For example, a POS system may include one or more POS devices and/or other like devices that may be used to conduct a payment transaction. In some non-limiting embodiments or aspects, a POS system (e.g., a merchant POS system) may include one or more server computers programmed or configured to process online payment transactions through webpages, mobile applications, and/or the like.

As used herein, the term “server” may refer to or include one or more computing devices that are operated by or facilitate communication and processing for multiple parties in a network environment, such as the Internet, although it will be appreciated that communication may be facilitated over one or more public or private network environments and that various other arrangements are possible. Further, multiple computing devices (e.g., servers, point-of-sale (POS) devices, mobile devices, etc.) directly or indirectly communicating in the network environment may constitute a “system.”

As used herein, the term “system” may refer to one or more computing devices or combinations of computing devices (e.g., processors, servers, client devices, software applications, components of such, and/or the like). Reference to “a device,” “a server,” “a processor,” and/or the like, as used herein, may refer to a previously-recited device, server, or processor that is recited as performing a previous step or function, a different device, server, or processor, and/or a combination of devices, servers, and/or processors. For example, as used in the specification and the claims, a first device, a first server, or a first processor that is recited as performing a first step or a first function may refer to the same or different device, server, or processor recited as performing a second step or a second function.

As used herein, the term “transaction service provider” may refer to an entity that receives transaction authorization requests from merchants or other entities and provides guarantees of payment, in some cases through an agreement between the transaction service provider and an issuer institution. For example, a transaction service provider may include a payment network such as Visa® or any other entity that processes transactions. The term “transaction processing system” may refer to one or more computer systems operated by or on behalf of a transaction service provider, such as a transaction processing server executing one or more software applications. A transaction processing server may include one or more processors and, in some non-limiting embodiments or aspects, may be operated by or on behalf of a transaction service provider.

Non-limiting embodiments or aspects of the disclosed subject matter are directed to methods, systems, and computer program products for controlling issuer transactions. For example, non-limiting embodiments enable a transaction processing system to control a prefunded account of an issuer system. During processing of electronic payment transactions by the transaction processing system, the accumulated authorization amount may be determined thereby, which enables the transaction processing system to track the amount of authorizations approved for the issuer system. The transaction processing system may further determine whether the accumulated authorization amount satisfies a threshold, which threshold may be based on the amount in the prefunded account of the issuer system (e.g., the threshold may equal the amount in the prefunded account, be a percentage thereof, and/or the like). In response to determining that the accumulated authorization amount satisfies the threshold for a particular transaction, the transaction processing system may automatically decline that transaction. Therefore, the transaction processing system may control transactions for an issuer system based on an amount in a prefunded account associated with the issuer system.

The transaction processing system may control the prefunded account of the issuer system. The transaction processing system may function as a filter of transaction request messages received from merchant system, which filter is specifically located between the merchant system and the issuer system for whom the prefunded account was generated. The transaction processing system may track, in real-time, an accumulated authorization amount of the issuer system to ensure that the accumulated authorization amount has not satisfied a threshold. As used in this context, “real-time” may refer to tracking the accumulated authorization amount in real-time relative to receiving the transaction request message from the merchant system (e.g., in real-time, in near real-time, during the event, as soon as practically available after the event, during processing and/or communication of messages related to the event, at the time of making a decision related to the event (e.g., receiving a transaction request message). For example, the term “real-time” may refer to performance of a task or tasks during another process or before another process is completed (e.g., before generation of an authorization request and/or termination of the transaction). The filter function of the transaction processing system as described herein may improve the efficiency of the electronic payment processing network and reduce the processing resources expended by the issuer system and/or the transaction processing system by causing the transaction processing system to only generate authorization requests for transactions in which the accumulated authorization amount has not satisfied the threshold. For a transaction in which the threshold is satisfied, the transaction processing system may automatically terminate the transaction and forgo generation of any authorization request for the transaction, such that no authorization request is received or processed by the issuer system for that transaction.

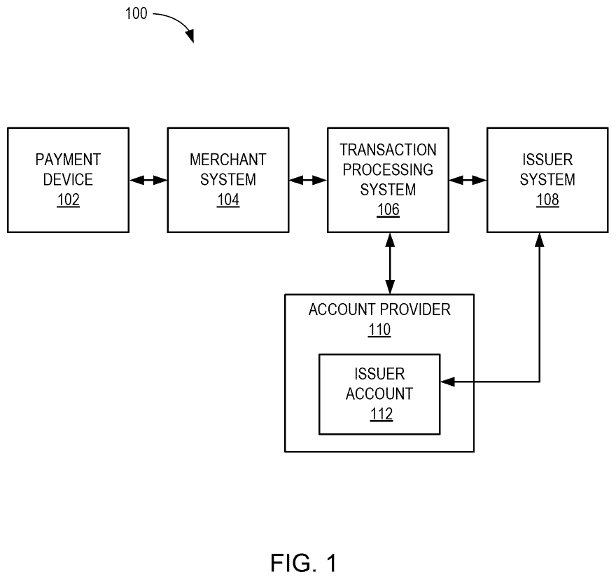

Referring now to FIG. 1, shown is a system 100 for controlling issuer transactions, according to some non-limiting embodiments or aspects. The system 100 may include payment device 102, merchant system 104, transaction processing system 106, issuer system 108, account provider 110, and/or issuer account 112.

Payment device 102 may include a payment device as previously described herein. In some non-limiting embodiments or aspects, a user device may store the payment device 102 (e.g., payment credentials of the payment device, such as a PAN, token, expiration date, cvv code, and the like) thereon such that the user device may be used to initiate the payment transaction with merchant system 104, or the payment device 102 may initiate the payment transaction with merchant system 104 without a user device. A user device may include one or more devices capable of (e.g., configured to) receiving information from and/or communicating information to merchant system 104 (e.g., directly via wired or wireless communication connection, indirectly via a communication network, and/or the like). For example, user device may include a computing device. User device may be capable of initiating an electronic payment transaction by communicating with merchant system 104.

Merchant system 104 may include one or more devices capable of receiving information from and/or communicating information to payment device 102 and/or transaction processing system 106 (e.g., directly via wired or wireless communication connection, indirectly via a communication network, and/or the like). For example, merchant system 104 may include a computing device, such as a server, a group of servers, and/or other like devices. Merchant system 104 may comprise a POS device or POS system, which may comprise a web server or a physical POS device.

Transaction processing system 106 may include one or more devices capable of receiving information from and/or communicating information to merchant system 104 and/or issuer system 108 and/or account provider 110 (e.g., directly via wired or wireless communication connection, indirectly via a communication network, and/or the like). For example, transaction processing system 106 may include a computing device, such as a server, a group of servers, and/or other like devices. In some non-limiting embodiments or aspects, transaction processing system 106 may transfer funds to and/or withdraw funds from issuer account 112 (or cause such).

Issuer system 108 may include one or more devices capable of receiving information from and/or communicating information to transaction processing system 106 and/or account provider 110 (including issuer account 112 thereof) (e.g., directly via wired or wireless communication connection, indirectly via a communication network, and/or the like). For example, issuer system 108 may include a computing device, such as a server, a group of servers, and/or other like devices. In some non-limiting embodiments or aspects, issuer system 108 may transfer funds to issuer account 112. In some non-limiting embodiments or aspects, issuer system 108 may not be enabled to withdraw funds from issuer account 112.

Account provider 110 may include one or more devices capable of receiving information from and/or communicating information to transaction processing system 106 and/or issuer system 108 (e.g., directly via wired or wireless communication connection, indirectly via a communication network, and/or the like). For example, account provider 110 may include a computing device, such as a server, a group of servers, and/or other like devices. Account provider 110 may create issuer account 112 (a prefunded account) associated with issuer system 108, which issuer account 112 may be a payment account containing funds of issuer system 108. Funds may be transferred to or withdrawn from issuer account 112.

The number and arrangement of systems and devices shown in FIG. 1 are provided as an example. There may be additional systems and/or devices, fewer systems and/or devices, different systems and/or devices, and/or differently arranged systems and/or devices than those shown in FIG. 1. Furthermore, two or more systems or devices shown in FIG. 1 may be implemented within a single system or device, or a single system or device shown in FIG. 1 may be implemented as multiple, distributed systems or devices. Additionally or alternatively, a set of systems (e.g., one or more systems) or a set of devices (e.g., one or more devices) of system 100 may perform one or more functions described as being performed by another set of systems or another set of devices of system 100.

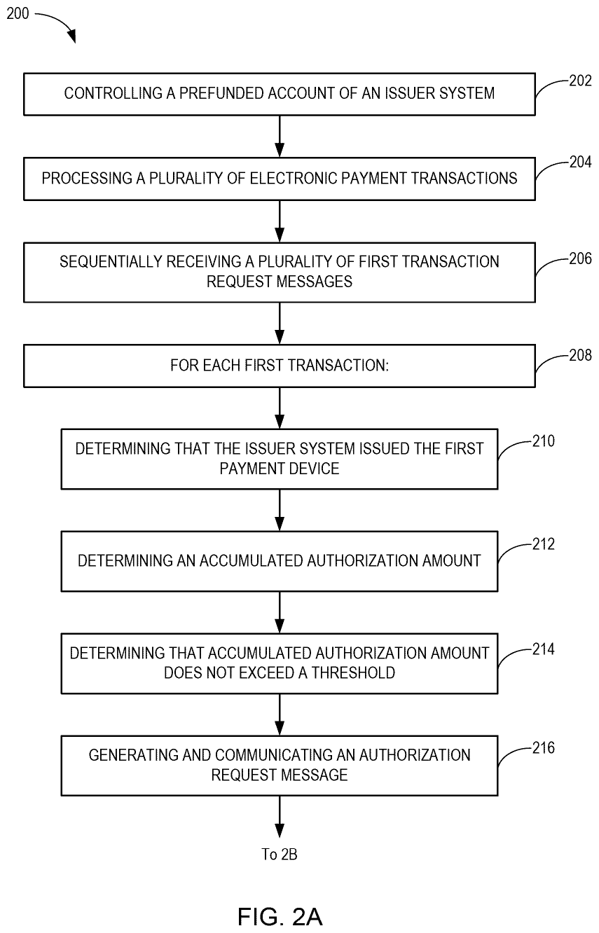

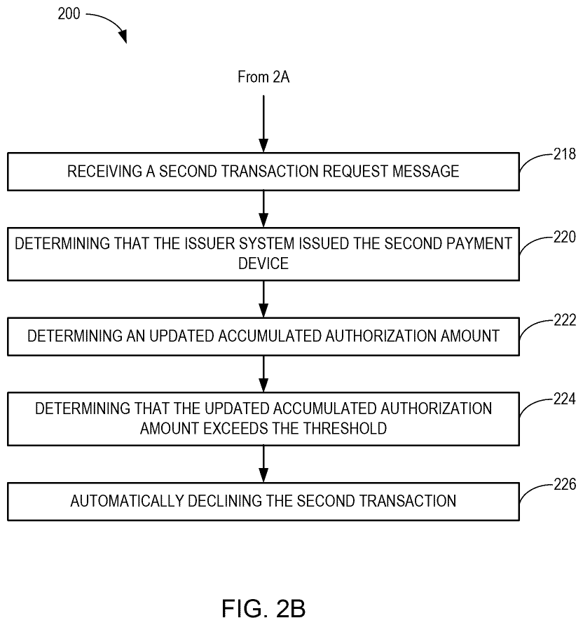

Referring now to FIGS. 2A-2B, shown is a flow diagram for a method for controlling issuer transactions, according to some non-limiting embodiments or aspects. The steps shown in FIGS. 2A-2B are for example purposes only. It will be appreciated that additional, fewer, different, and/or a different order of steps may be used in some non-limiting embodiments or aspects. In some non-limiting embodiments or aspects, a step may be automatically performed in response to performance and/or completion of a prior step.

In some non-limiting embodiments or aspects, one or more of the steps of process 200 may be performed (e.g., completely, partially, and/or the like) by transaction processing system 106 (e.g., one or more devices thereof). In some non-limiting embodiments or aspects, one or more of the steps of process 200 may be performed (e.g., completely, partially, and/or the like) by another system, another device, another group of systems, or another group of devices, separate from or including transaction processing system 106, such as payment device 102, merchant system 104, issuer system 108, account provider 110, issuer account 112, and/or the like.

As shown in FIGS. 2A-2B, at step 202, process 200 may include controlling a prefunded account of issuer system 108 by transaction processing system 106, the prefunded account containing a prefunded amount. For example, transaction processing system 106 may control issuer account 112 (a prefunded account associated with issuer system 108). Controlling the issuer account 112 may include transaction processing system 106 transferring and/or withdrawing and/or causing to be transferred and/or withdrawn funds from the issuer account 112.

In some non-limiting embodiments or aspects, transaction processing system 106 may be capable of transferring funds from the issuer account 112, but issuer system 108 is not capable of transferring funds from issuer account 112. For example, permissions may be established for issuer account 112 such that certain systems can and certain systems cannot transfer funds from issuer account 112. For example, account provider 110 may establish permissions for issuer account 112 enabling transaction processing system 106 to initiate transfers of funds from issuer account 112 while prohibiting issuer system 108 from initiating transfers of funds from issuer account 112. In some non-limiting embodiments, transaction processing system 106 may present credentials to account provider 110 that, once confirmed by account provider 110, enable transaction processing system 106 to initiate a transfer of funds from issuer account 112.

In some non-limiting embodiments or aspects, controlling the prefunded account may comprise configuring transaction processing system 106 to be capable of transferring at least a portion of the prefunded amount from issuer account 112. Configuring transaction processing system 106 to be capable of transferring at least a portion of the prefunded amount from issuer account 112 may comprise transaction processing system 106 (e.g., a component thereof) transferring funds from issuer account 112 or causing the funds to be transferred from issuer account 112.

At step 204, process 200 may include processing a plurality of electronic payment transactions initiated by a plurality of users using a plurality of payment devices 102 issued by issuer system 108. For example, transaction processing system 106 may process the plurality of electronic payment transactions. Processing the electronic payment transactions may include authorizing, clearing, and/or settling the electronic payment transactions. The electronic payment transactions may be processed according to steps 206-226 described hereinafter.

At step 206, process 200 may include sequentially receiving a plurality of first transaction request messages associated with a plurality of first transactions initiated by a plurality of first payment devices 102 of the plurality of payment devices 102 issued by issuer system 108. Each of the plurality of first transactions has an associated first transaction amount. The plurality of transaction request messages may be received by transaction processing system 106 from a plurality of merchant systems 104. The transaction request messages may be associated with electronic payment transactions initiated between users and merchants initiated using payment devices 102.

With continued reference to FIGS. 2A-2B, at step 208, process 200 may include processing each of the first transactions. Processing each of the first transactions may include executing each of steps 210-216 described hereinafter.

At step 210, process 200 may include, in response to receiving the first transaction request message, determining that issuer system 108 issued a corresponding first payment device 102 based on transaction data contained in the first transaction message. For example, transaction processing system 106 may determine that issuer system 108 issued a corresponding first payment device 102. The transaction data contained in the first transaction message may comprise an identifier that identifies the issuer system with which the transaction is associated, such as a PAN.

At step 212, process 200 may include determining an accumulated authorization amount based on preceding transaction amounts of the plurality of first transactions that have been authorized and the corresponding first transaction amount. For example, transaction processing system 106 may determine the accumulated authorization amount. The accumulated authorization amount may track a sum of an amount of electronic payment transactions that have been authorized for the particular issuer system 108 over a time period, which may represent a cumulative amount an issuer still owes merchant systems 104 for payment transactions initiated by payment devices 102 it issued. Transaction processing system 106 may add to a running total of accumulated authorization amount an additional amount based on the initiation of a new electronic payment transaction associate with a payment device 102 issued by issuer system 108.

At step 214, process 200 may include determining that the accumulated authorization amount does not satisfy a threshold based on the prefunded amount. For example, transaction processing system 106 may determine that the accumulated authorization amount does not satisfy a threshold based on the prefunded amount. The threshold may be the prefunded amount in issuer account 112 or some predetermined percentage thereof.

In some non-limiting embodiments or aspects, issuer system 108 may transfer additional funds to issuer account 112. In response to the issuer system transferring the additional funds to issuer account 112, the threshold may be updated based on the additional funds, such as by adding the amount of additional funds to the current amount in the prefunded issuer account 112. Transaction processing system 106 may update the balance in the issuer account 112.

In some non-limiting embodiments or aspects, transaction processing system 106 may receive a webhook notification and/or other type of message automatically in response to issuer system 108 transferring the additional funds to issuer account 112. The message may include information about the transfer, such as a confirmation, amount, and/or the like.

In some non-limiting embodiments or aspects, issuer system 108 may transfer the additional funds to issuer account 112 during processing at least one of the plurality of first transactions. The balance in the issuer account 112 may be updated based on this transfer to the issuer account 112 during processing at least one of the plurality of first transactions.

With continued reference to FIGS. 2A-2B, at step 216, process 200 may include, in response to determining that the accumulated authorization amount does not satisfy the threshold, generating and communicating an authorization request message associated with the corresponding first transaction to issuer system 108. For example, transaction processing system 106 may generate and communicate the authorization request message to issuer system 108.

At step 218, process 200 may include receiving, from merchant system 104, a second transaction request message associated with a second transaction initiated by a payment device 102 of the plurality of payment devices 102 issued by issuer system 108, the second transaction having an associated second transaction amount. The merchant system 104 may be the same or different merchant system 104 as the merchant system 104 in the first transaction. The payment device 102 may be the same or different payment device 102 as the payment device 102 in the first transaction. For example, transaction processing system 106 may receive the second transaction request.

At step 220, process 200 may include, in response to receiving the second transaction request message, determining that issuer system 108 issued payment device 102 based on transaction data contained in the second transaction message. For example, transaction processing system 106 may determine that issuer system 108 issued payment device 102 based on transaction data contained in the second transaction message.

At step 222, process 200 may include determining an updated accumulated authorization amount based on the accumulated authorization amount and the second transaction amount. For example, transaction processing system 106 may determine the updated accumulated authorization amount based on the accumulated authorization amount and the second transaction amount. For example, the updated accumulated authorization amount may be the sum of the accumulated authorization amount and the second transaction amount, optionally less any transaction amounts settled by issuer system 108 between the determination of the accumulated authorization amount and the determination of the updated accumulated authorization amount.

At step 224, process 200 may include determining that the updated accumulated authorization amount satisfies the threshold. For example, transaction processing system 106 may determine that the updated accumulated authorization amount satisfies a threshold based on the prefunded amount. The threshold may be the prefunded amount in issuer account 112 or some predetermined percentage thereof. The threshold in step 224 may be the same or different threshold compared to step 214.

At step 226, process 200 may include, in response to determining that the updated accumulated authorization amount satisfies the threshold, automatically declining the second transaction. For example, transaction processing system 106 may automatically decline the second transaction. Unlike in step 216, in response to determining that the updated accumulated authorization amount satisfies the threshold, transaction processing system 106 may not generate and communicate an authorization request message to issuer system 108.

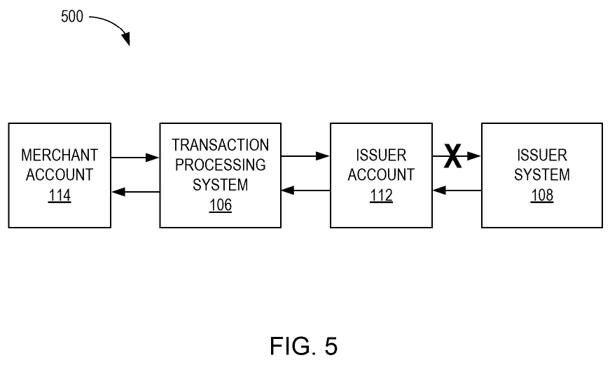

In some non-limiting embodiments or aspects, process 200 may include, during settlement of a transaction of the plurality of first transactions, automatically transferring, by transaction processing system 106, at least a portion of the first transaction amount corresponding to the transaction from prefunded issuer account 112 to an account of merchant system 104 corresponding to the transaction (e.g., merchant account 114 (see e.g., FIG. 5)). This may include the transaction processing system 106 automatically transferring at least a portion of the first transaction amount corresponding to the transaction from prefunded issuer account 112 directly to merchant account 114 or indirectly to merchant account 114 via an account of an acquirer system of the merchant (e.g., the transaction service provider may settle with the acquirer which may settle with the merchant). The automatic transfer being executed by transaction processing system 106 may include transaction processing system 106 transferring the funds or causing the transfer of the funds.

The automatic transfer may be executed in response to a default message associated with issuer system 108. The default message may indicate that the issuer of the issuer system 108 has defaulted, is insolvent, has been disabled from processing electronic payment transactions over the payment network of transaction processing system 106, and/or the like.

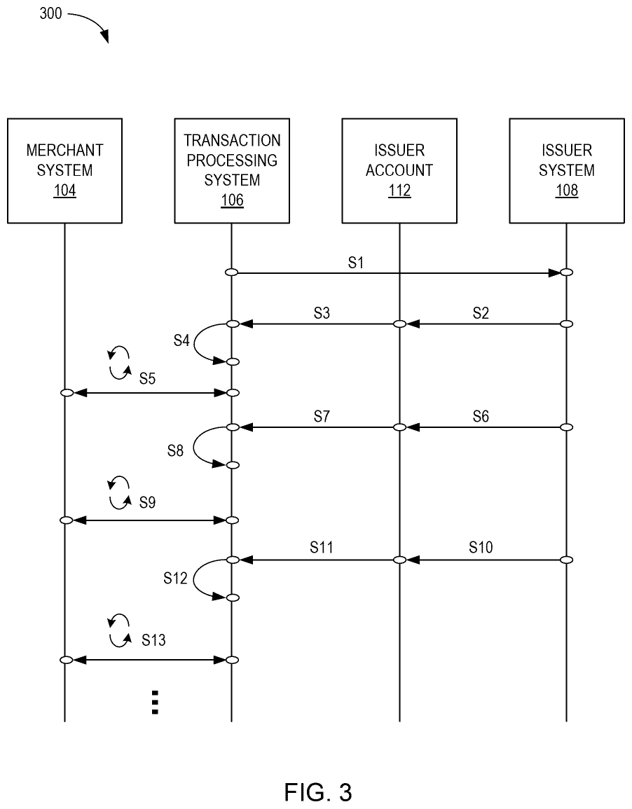

Referring to FIG. 3, a process flow diagram is shown of an example system 300 for controlling issuer transactions. At a step S1, transaction processing system 106 may control prefunded issuer account 112 of issuer system 108. Transaction processing system 106 controlling issuer account 112 may comprise configuring transaction processing system 106 to transfer at least a portion of funds from issuer account 112. Issuer system 108 may not be configured to transfer funds from issuer account 112, but may be configured to transfer funds to issuer account 112 (e.g., to fund issuer account 112). Thus, transaction processing system 106 may be configured to transfer funds from the issuer account 112, but the issuer system 108 may not be configured to transfer funds from the issuer account 112.

Controlling the issuer account so that transaction processing system 106 may be configured to transfer funds from the issuer account 112, but the issuer system 108 may not be configured to transfer funds from issuer account 112, may be effected by generating transfer control credentials used by issuer account 112 during requests to transfer funds therefrom. For example, a credential may be generated for transaction processing system 106, and no credential may be generated for issuer system 108. During a request to transfer funds from issuer account 112, transaction processing system 106 may provide its credential (e.g., as a field in the transfer request), and issuer account 112 and/or account provider 110 (from FIG. 1) may validate the credential and allow transaction processing system 106 to transfer funds therefrom. During a request to transfer funds from issuer account 112, issuer system 108 may not provide any credential, and issuer account 112 may not enable issuer system 108 to transfer funds from issuer account 112 due to its lack of valid credential.

While a non-limiting example of controlling issuer account 112 to only enable fund transfers therefrom by transaction processing system 106 and not issuer system 108 has been described herein, it will be appreciated that any suitable mechanism for generating and implementing such controls may be used.

In some non-limiting embodiments or aspects, controlling issuer account 112 may include transaction processing system 106 generating at least one threshold for issuer account 112. The threshold may include at least one threshold amount of funds in issuer account 112, at least one threshold count of transactions handled by issuer account 112, at least one velocity (e.g., funds over a time period) of funds that may be handled by issuer account 112 over time, and the like. Transactions (e.g., electronic payment transactions) associated with issuer system 108 requesting funds from issuer account 112 may be processed according to the generated threshold. Transaction processing system 106 may communicate the threshold(s) generated for issuer account 112 to issuer system 108.

At step S2, issuer system 108 may fund issuer account 112 with a prefunded amount. Funding issuer account 112 may comprise issuer system 108 transferring funds to issuer account 112, such that issuer account 112 may be a prefunded account from which settlement amounts may be transferred (e.g., by transaction processing system 106) to merchant accounts to settle payment transactions associated with issuer system 108. Issuer system 108 may prefund issuer account 112 with some amount of funds above the threshold.

In some non-limiting embodiments or aspects, at a step S3, in response to issuer system 108 funding issuer account 112, a notification may be generated and transmitted to transaction processing system 106 to notify transaction processing system 106 that issuer account 112 has been funded and/or of the specific amount of funds transferred to issuer account 112. The notification may comprise a webhook notification generated in response to the funding of issuer account 112.

At a step S4, in response to issuer account 112 being funded, transaction processing system 106 may determine an excess amount, which may comprise a difference between the threshold and the amount by which issuer account 112 has been funded.

With continued reference to FIG. 3, in some non-limiting embodiments or aspects, at a step S5, transaction processing system 106 may process a plurality of first electronic payment transactions initiated by a plurality of different users using a plurality of payment devices issued by issuer system 108. Each of the users may be a user to whom issuer system 108 has issued a payment device for initiating electronic payment transactions. The electronic payment transactions may comprise transactions between users and merchants, for example by users initiating payment transactions with merchant systems 104 using their payment devices. While a single merchant system 104 is shown in FIG. 3, it will be appreciated that transaction processing system 106 may communicate with a plurality of merchant systems 104 to process transactions of the user having payment devices issued by issuer system 108.

Transaction processing system 106 may process each of the plurality of first transactions by sequentially receiving, from a plurality of merchant systems 104, a plurality of first transaction request messages associated with the plurality of first transactions. Each of the first transactions is initiated by one of a plurality of first payment devices of the plurality of payment devices issued by issuer system 108. Each first transaction of the plurality of first transactions may have an associated first transaction amount.

For each first transaction of the plurality of first transactions, in response to receiving the first transaction request message, transaction processing system 106 may determine that the issuer system 108 issued the corresponding first payment device based on transaction data contained in the first transaction request message. For example, transaction processing system 106 may determine that the first payment device was issued by issuer system 108 based on the PAN contained in the first transaction request message.

For each first transaction of the plurality of first transactions, transaction processing system 106 may determine an accumulated authorization amount based on preceding transaction amounts of the plurality of first transactions that have been authorized and the corresponding first transaction amount. For example, for the first transaction of the sequentially received plurality of first transactions, the accumulated authorization amount may comprise the transaction amount of the first transaction, while for the second transaction of the sequentially received plurality of first transactions, the accumulated authorization amount may comprise the transaction amount of the first transaction plus the transaction amount of the second transaction.

For each first transaction of the plurality of first transactions, transaction processing system 106 may determine whether the accumulated authorization amount satisfies the threshold, for example based on the prefunded amount in issuer account 112 and the determined accumulated authorization amount. For example, transaction processing system 106 may determine whether the accumulated authorization amount satisfies or does not satisfy the threshold. This may be based on the prefunded amount in issuer account 112, the accumulated authorization amount, and the threshold (e.g., a minimum permissible balance in issuer account 112).

In response to determining that the accumulated authorization amount satisfies the threshold, transaction processing system 106 may automatically decline and/or terminate the payment transaction. The transaction processing system 106 may forgo generating and communicating an authorization request message associated with the transaction to the issuer system 108. No authorization request message may be sent to issuer system 108 for such transaction because issuer account 112 may not have sufficient funds according to the threshold.

In response to determining that the accumulated authorization amount does not satisfy the threshold, transaction processing system 106 may automatically generate and communicate an authorization request message associated with the corresponding first transaction to issuer system 108. Issuer system 108 may determine whether to approve and/or decline the payment transaction.

In response to issuer system 108 declining the transaction, the payment transaction may be terminated.

In response to issuer system 108 approving the transaction, the payment transaction may be cleared and/or settled. During settlement of the approved transaction, transaction processing system 106 may automatically transfer at least a portion of the transaction amount corresponding to the transaction from issuer account 112 to an account of merchant system 104 corresponding to the transaction, thus reducing the balance in prefunded issuer account 112. In some non-limiting embodiments or aspects, the automatic transfer may be executed in response to a default message associated with issuer system 108 indicating default of the issuer.

As described herein, in step S5, transaction processing system 106 may control transactions of issuer system 108 based on the threshold, such that authorization requests are generated and transmitted to issuer system 108 only when the threshold is not satisfied, thus functioning as a filter to issuer system 108 arranged at a particular location. Transaction processing system's 106 control in this way enables real-time (relative to receiving the transaction request message) control of issuer system 108 transactions and ensures that issuer account 112 is not overdrawn. Real-time control may refer to control in real-time, near real-time, during the event, as soon as practically available after the event, during processing and/or communication of messages related to the event, at the time of making a decision or determination related to the event (e.g., determining accumulated authorization amount and/or whether accumulated authorization amount satisfies the threshold), and/or the like). For example, the term “real-time” may refer to performance of a task or tasks during another process or before another process is completed. In some non-limiting embodiments or aspects, real-time may refer to a delay that is imperceptible or near imperceptible to a user under the circumstance.

With continued reference to FIG. 3, in some non-limiting embodiments or aspects, at step S6, issuer system 108 may re-fund issuer account 112. Issuer system 108 may re-fund issuer account 112 by transferring additional funds to issuer account 112. In response, the balance of funds in issuer account 112 may be updated based on the additional funds. Issuer system 108 may transfer the additional funds to issuer account 112 to re-fund issuer account 112 at any time during or after processing of the plurality of first transactions described in step S5.

In some non-limiting embodiments or aspects, at a step S7, in response to issuer system 108 re-funding issuer account 112, a notification may be generated and transmitted to transaction processing system 106 to notify transaction processing system 106 that issuer account 112 has been re-funded and/or of the specific amount of funds transferred to issuer account 112. The notification may comprise a webhook notification generated in response to the re-funding of issuer account 112.

At a step S8, in response to issuer account 112 being re-funded, transaction processing system 106 may determine an updated excess amount, which may comprise a difference between the threshold and the updated balance of issuer account 112.

With continued reference to FIG. 3, in some non-limiting embodiments or aspects, at step 9, transaction processing system 106 may process a plurality of second electronic payment transactions initiated by a plurality of different users using a plurality of payment devices issued by issuer system 108. The second plurality of payment transactions may be processed in a similar manner compared to the plurality of first electronic payment transactions as described in step S5, but using the threshold, the updated excess amount, and/or the updated balance of issuer account 112. Transactions of the plurality of second transactions for which the accumulated transaction amount satisfies the threshold may be automatically declined as described in step S5, and transactions of the plurality of second transactions for which the accumulated transaction amount does not satisfy the threshold may be automatically further processed as described in step S5.

With continued reference to FIG. 3, in some non-limiting embodiments or aspects, steps S10-S13 may correspond to steps S6-S9, respectively, but with a second re-funding of issuer account 112 by issuer system 108 and a processing of a plurality of third electronic payment transactions by transaction processing system 106.

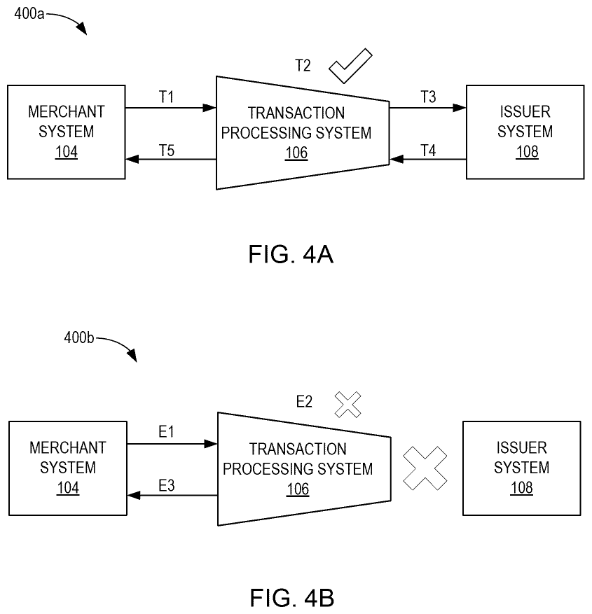

Referring to FIGS. 4A-4B, systems 400a-b are shown for controlling issuer transactions, particularly with respect to transaction processing system 106 functioning as a filter arranged between merchant system 104 and issuer system 108, allowing authorization requests for certain transactions to be transmitted to issuer system 108 while preventing authorization requests for other transactions from being transmitted to issuer system 108. Such arrangement as described herein may conserve processing resources of at least one of merchant system 104, transaction processing system 106 and/or issuer system 108.

FIG. 4A shows a non-limiting embodiment of the system 400a in which an authorization request for a transaction is transmitted to issuer system 108. At a step T1, transaction processing system 106 may receive a transaction request message associated with a payment transaction from merchant system 104. At a step T2, transaction processing system 106 may: determine that issuer system 108 issued the payment device initiating the payment transaction; determine the accumulated authorization amount; and determine whether the accumulated authorization amount satisfies the threshold (as described in step S5 of FIG. 3). In this non-limiting embodiment, at step T2, transaction processing system 106 may determine that the accumulated authorization amount does not satisfy the threshold.

At step T3, transaction processing system 106 may generate an authorization request for the payment transaction and transmit the authorization request to issuer system 108. At a step T4, in response to receiving the authorization request, issuer system 108 may generate an authorization decision. The authorization decision may be based on transaction data for the payment transaction. The authorization decision may be to authorize and/or decline the payment transaction. Issuer system 108 may generate and transmit an authorization response comprising the authorization decision to transaction processing system 106. At a step T5, transaction processing system 106 may generate and transmit a transaction response message based on the authorization response. The transaction response message may be transmitted to merchant system 104. The transaction may be processed to completion by the system 400a.

FIG. 4B shows a non-limiting embodiment of the system 400b in which an authorization request for a transaction is not generated or transmitted to issuer system 108. At a step E1, transaction processing system 106 may receive a transaction request message associated with a payment transaction from merchant system 104. At a step E2, transaction processing system 106 may: determine that issuer system 108 issued the payment device initiating the payment transaction; determine the accumulated authorization amount; and determine whether the accumulated authorization amount satisfies the threshold (as described in step S5 of FIG. 3). In this non-limiting embodiment, at step E2, transaction processing system 106 may determine that the accumulated authorization amount satisfies the threshold.

At step E3, transaction processing system 106 may not generate an authorization request for the payment transaction in response to determining that the accumulated authorization amount satisfies the threshold, such that no authorization request is transmitted to issuer system 108 (thus conserving processing resources of issuer system 108 and the payment processing network). Instead, transaction processing system 106 may automatically decline the transaction. Transaction processing system 106 may generate and transmit a transaction response message based on the payment transaction being declined. The transaction response message may be transmitted to merchant system 104. Processing of the transaction may be terminated by the system 400b.

Referring to FIG. 5, a system is shown for controlling issuer transactions particularly with respect to controlling issuer account 112. Issuer account 112 may be in communication with transaction processing system 106 and issuer system 108. As shown in FIG. 5, issuer system 108 may transfer funds to issuer account 112 to be used in payment transactions of users to whom it has issued a payment device. However, issuer system 108 may not transfer funds from issuer account 112 (e.g., may not withdraw funds from issuer account 112). Issuer system 108 may transfer funds to issuer account 112 to fund and/or re-fund issuer account 112 as described herein.

In contrast, transaction processing system 106 may both transfer funds to issuer account 112 and/or transfer funds from issuer account 112. Transaction processing system 106 may transfer funds from issuer account 112 to merchant account 114 during settlement of a payment transaction. Transaction processing system 106 may transfer funds to issuer account 112 from merchant account 114, such as during a return protocol and/or processing of a chargeback.

Control of issuer account 112, such as enabling the system(s) that may/may not transfer funds to and/or from issuer account 112, may be effected as described herein, such as by generating credentials associated with permissions for activities that a system is enabled/not enabled to perform with respect to issuer account 112.

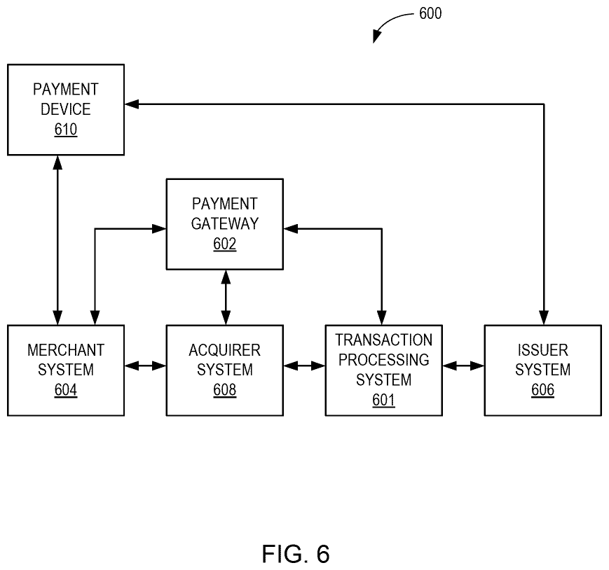

FIG. 6 shows an electronic payment processing network 600 according to non-limiting embodiments or aspects. The electronic payment processing network 600 may be used in conjunction with the systems and methods described herein. It will be appreciated that the particular arrangement of electronic payment processing network 600 shown is for example purposes only, and that various arrangements are possible. Transaction processing system 601 (e.g., a transaction handler) is shown to be in communication with one or more issuer systems (e.g., such as issuer system 606) and one or more acquirer systems (e.g., such as acquirer system 608). Although only a single issuer system 606 and single acquirer system 608 are shown, it will be appreciated that transaction processing system 601 may be in communication with a plurality of issuer systems and/or acquirer systems. In some embodiments, transaction processing system 601 may also operate as an issuer system such that both transaction processing system 601 and issuer system 606 are a single system and/or controlled by a single entity.

In some non-limiting embodiments or aspects, transaction processing system 601 may communicate with merchant system 604 directly through a public or private network connection. Additionally or alternatively, transaction processing system 601 may communicate with merchant system 604 through payment gateway 602 and/or acquirer system 608. In some non-limiting embodiments or aspects, an acquirer system 608 associated with merchant system 604 may operate as payment gateway 602 to facilitate the communication of transaction requests from merchant system 604 to transaction processing system 601. Merchant system 604 may communicate with payment gateway 602 through a public or private network connection. For example, a merchant system 604 that includes a physical POS device may communicate with payment gateway 602 through a public or private network to conduct card-present transactions. As another example, a merchant system 604 that includes a server (e.g., a web server) may communicate with payment gateway 602 through a public or private network, such as a public Internet connection, to conduct card-not-present transactions.

In some non-limiting embodiments or aspects, transaction processing system 601, after receiving a transaction request from merchant system 604 that identifies an account identifier of a payor (e.g., such as an account holder) associated with an issued payment device 610, may generate an authorization request message to be communicated to the issuer system 606 that issued the payment device 610 and/or account identifier. Issuer system 606 may then approve or decline the authorization request and, based on the approval or denial, generate an authorization response message that is communicated to transaction processing system 601. Transaction processing system 601 may communicate an approval or denial to merchant system 604. When issuer system 606 approves the authorization request message, it may then clear and settle the payment transaction between the issuer system 606 and acquirer system 608.

Transaction processing system 601 may correspond to transaction processing system 106. Merchant system 604 may correspond to merchant system 104. Issuer system 606 may correspond to issuer system 108. Payment device 610 may correspond to payment device 102.

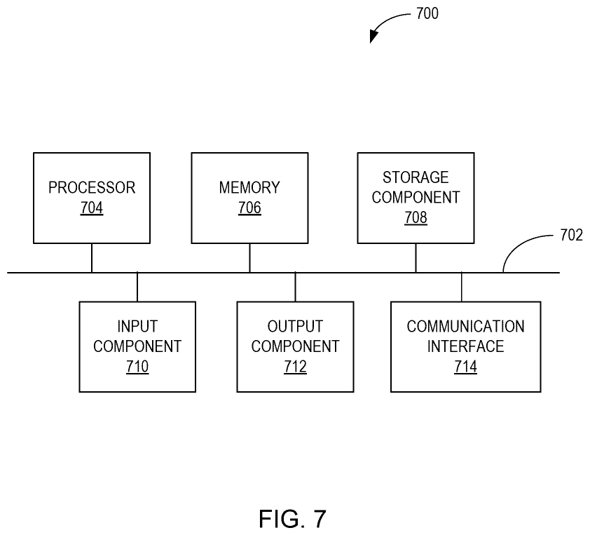

Referring now to FIG. 7, shown is a diagram of example components of a device 700 according to non-limiting embodiments. Device 700 may correspond to any of the components shown in FIG. 1, 3, or 4A-6, such as payment device 102, merchant system 104, transaction processing system 106, issuer system 108, account provider 110, issuer account 112, merchant account 114, transaction processing system 601, payment gateway 602, merchant system 604, issuer system 606, acquirer system 608, and/or payment device 610, as an example. In some non-limiting embodiments, such systems or devices may include at least one device 700 and/or at least one component of device 700. The number and arrangement of components shown are provided as an example. In some non-limiting embodiments, device 700 may include additional components, fewer components, different components, or differently arranged components than those shown. Additionally, or alternatively, a set of components (e.g., one or more components) of device 700 may perform one or more functions described as being performed by another set of components of device 700.

As shown in FIG. 7, device 700 may include a bus 702, a processor 704, memory 706, a storage component 708, an input component 710, an output component 712, and a communication interface 714. Bus 702 may include a component that permits communication among the components of device 700. In some non-limiting embodiments, processor 704 may be implemented in hardware, firmware, or a combination of hardware and software. For example, processor 704 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function. Memory 706 may include random access memory (RAM), read only memory (ROM), and/or another type of dynamic or static storage device (e.g., flash memory, magnetic memory, optical memory, etc.) that stores information and/or instructions for use by processor 704.

With continued reference to FIG. 7, storage component 708 may store information and/or software related to the operation and use of device 700. For example, storage component 708 may include a hard disk (e.g., a magnetic disk, an optical disk, a magneto-optic disk, a solid-state disk, etc.) and/or another type of computer-readable medium. Input component 710 may include a component that permits device 700 to receive information, such as via user input (e.g., a touch screen display, a keyboard, a keypad, a mouse, a button, a switch, a microphone, etc.). Additionally, or alternatively, input component 710 may include a sensor for sensing information (e.g., a global positioning system (GPS) component, an accelerometer, a gyroscope, an actuator, etc.). Output component 712 may include a component that provides output information from device 700 (e.g., a display, a speaker, one or more light-emitting diodes (LEDs), etc.). Communication interface 714 may include a transceiver-like component (e.g., a transceiver, a separate receiver and transmitter, etc.) that enables device 700 to communicate with other devices, such as via a wired connection, a wireless connection, or a combination of wired and wireless connections. Communication interface 714 may permit device 700 to receive information from another device and/or provide information to another device. For example, communication interface 714 may include an Ethernet interface, an optical interface, a coaxial interface, an infrared interface, a radio frequency (RF) interface, a universal serial bus (USB) interface, a Wi-Fi® interface, a cellular network interface, and/or the like.

Device 700 may perform one or more processes described herein. Device 700 may perform these processes based on processor 704 executing software instructions stored by a computer-readable medium, such as memory 706 and/or storage component 708. A computer-readable medium may include any non-transitory memory device. A memory device includes memory space located inside of a single physical storage device or memory space spread across multiple physical storage devices. Software instructions may be read into memory 706 and/or storage component 708 from another computer-readable medium or from another device via communication interface 714. When executed, software instructions stored in memory 706 and/or storage component 708 may cause processor 704 to perform one or more processes described herein. Additionally, or alternatively, hardwired circuitry may be used in place of or in combination with software instructions to perform one or more processes described herein. Thus, embodiments described herein are not limited to any specific combination of hardware circuitry and software. The term “configured to,” as used herein, may refer to an arrangement of software, device(s), and/or hardware for performing and/or enabling one or more functions (e.g., actions, processes, steps of a process, and/or the like). For example, “a processor configured to” may refer to a processor that executes software instructions (e.g., program code) that cause the processor to perform one or more functions.

Although embodiments or aspects have been described in detail for the purpose of illustration, it is to be understood that such detail is solely for that purpose and that the disclosure is not limited to the disclosed embodiments or aspects, but, on the contrary, is intended to cover modifications and equivalent arrangements that are within the spirit and scope of the appended claims. For example, it is to be understood that the present disclosure contemplates that, to the extent possible, one or more features of any embodiment or aspect can be combined with one or more features of any other embodiment or aspect.

What is claimed is:

1. A computer-implemented method comprising:
controlling a prefunded account of an issuer system by a transaction processing system, the prefunded account containing a prefunded amount;
processing, with at least one processor of the transaction processing system, a plurality of electronic payment transactions initiated by a plurality of users using a plurality of payment devices issued by the issuer system by:
sequentially receiving, from a plurality of first merchant systems, a plurality of first transaction request messages associated with a plurality of first transactions initiated by a plurality of first payment devices of the plurality of payment devices issued by the issuer system, each first transaction of the plurality of first transactions having an associated first transaction amount;
for each first transaction of the plurality of first transactions:
in response to receiving the first transaction request message, determining that the issuer system issued a corresponding first payment device based on transaction data contained in the first transaction request message;
determining an accumulated authorization amount based on preceding transaction amounts of the plurality of first transactions that have been authorized and the corresponding first transaction amount;
determining that the accumulated authorization amount does not satisfy a threshold based on the prefunded amount; and
in response to determining that the accumulated authorization amount does not satisfy the threshold, generating and communicating an authorization request message associated with the corresponding first transaction to the issuer system;
receiving, from a second merchant system, a second transaction request message associated with a second transaction initiated by a second payment device of the plurality of payment devices issued by the issuer system, the second transaction having an associated second transaction amount;
in response to receiving the second transaction request message, determining that the issuer system issued the second payment device based on transaction data contained in the second transaction request message;
determining an updated accumulated authorization amount based on the accumulated authorization amount and the second transaction amount;
determining that the updated accumulated authorization amount satisfies the threshold; and
in response to determining that the updated accumulated authorization amount satisfies the threshold, automatically declining the second transaction.

2. The computer-implemented method of claim 1, wherein the transaction processing system is configured to transfer funds from the prefunded account, but the issuer system is not configured to transfer funds from the prefunded account.

3. The computer-implemented method of claim 1, wherein the issuer system transfers additional funds to the prefunded account, the computer-implemented method further comprising:
in response to the issuer system transferring the additional funds to the prefunded account, updating a balance in the prefunded account based on the additional funds.

4. The computer-implemented method of claim 3, further comprising:
receiving, by the transaction processing system, a webhook notification in response to the issuer system transferring the additional funds to the prefunded account.

5. The computer-implemented method of claim 3, wherein the issuer system transfers the additional funds to the prefunded account during processing of at least one of the plurality of first transactions.

6. The computer-implemented method of claim 1, wherein controlling the prefunded account comprises configuring the transaction processing system to transfer at least a portion of the prefunded amount from the prefunded account.

7. The computer-implemented method of claim 1, further comprising:
during settlement of a transaction of the plurality of first transactions, automatically transferring, by the transaction processing system, at least a portion of the first transaction amount corresponding to the transaction from the prefunded account to an account of the first merchant system corresponding to the transaction.

8. The computer-implemented method of claim 7, wherein the automatic transfer is executed in response to a default message associated with the issuer system.

9. A system comprising at least one processor of a transaction processing system, the at least one processor configured to:
control a prefunded account of an issuer system by the transaction processing system, the prefunded account containing a prefunded amount;
process a plurality of electronic payment transactions initiated by a plurality of users using a plurality of payment devices issued by the issuer system by:
sequentially receiving, from a plurality of first merchant systems, a plurality of first transaction request messages associated with a plurality of first transactions initiated by a plurality of first payment devices of the plurality of payment devices issued by the issuer system, each first transaction of the plurality of first transactions having an associated first transaction amount;
for each first transaction of the plurality of first transactions:
in response to receiving the first transaction request message, determining that the issuer system issued a corresponding first payment device based on transaction data contained in the first transaction request message;
determining an accumulated authorization amount based on preceding transaction amounts of the plurality of first transactions that have been authorized and the corresponding first transaction amount;
determining that the accumulated authorization amount does not satisfy a threshold based on the prefunded amount; and
in response to determining that the accumulated authorization amount does not satisfy the threshold, generating and communicating an authorization request message associated with the corresponding first transaction to the issuer system;
receiving, from a second merchant system, a second transaction request message associated with a second transaction initiated by a second payment device of the plurality of payment devices issued by the issuer system, the second transaction having an associated second transaction amount;
in response to receiving the second transaction request message, determining that the issuer system issued the second payment device based on transaction data contained in the second transaction request message;
determining an updated accumulated authorization amount based on the accumulated authorization amount and the second transaction amount;
determining that the updated accumulated authorization amount satisfies the threshold; and
in response to determining that the updated accumulated authorization amount satisfies the threshold, automatically declining the second transaction.

10. The system of claim 9, wherein the transaction processing system is configured to transfer funds from the prefunded account, but the issuer system is not configured to transfer funds from the prefunded account.

11. The system of claim 9, wherein the issuer system transfers additional funds to the prefunded account, the at least one processor configured to:
in response to the issuer system transferring the additional funds to the prefunded account, update a balance in the prefunded account based on the additional funds.

12. The system of claim 11, the at least one processor configured to:
receive a webhook notification in response to the issuer system transferring the additional funds to the prefunded account.

13. The system of claim 11, wherein the issuer system transfers the additional funds to the prefunded account during processing of at least one of the plurality of first transactions.

14. The system of claim 9, wherein controlling the prefunded account comprises configuring the transaction processing system to transfer at least a portion of the prefunded amount from the prefunded account.

15. The system of claim 9, the at least one processor configured to:
during settlement of a transaction of the plurality of first transactions, automatically transfer at least a portion of the first transaction amount corresponding to the transaction from the prefunded account to an account of the first merchant system corresponding to the transaction.

16. The system of claim 15, wherein the automatic transfer is executed in response to a default message associated with the issuer system.

17. A computer program product comprising at least one non-transitory computer-readable medium including program instructions that, when executed by at least one processor, cause the at least one processor of a transaction processing system to:
control a prefunded account of an issuer system by the transaction processing system, the prefunded account containing a prefunded amount;
process a plurality of electronic payment transactions initiated by a plurality of users using a plurality of payment devices issued by the issuer system by:
sequentially receiving, from a plurality of first merchant systems, a plurality of first transaction request messages associated with a plurality of first transactions initiated by a plurality of first payment devices of the plurality of payment devices issued by the issuer system, each first transaction of the plurality of first transactions having an associated first transaction amount;
for each first transaction of the plurality of first transactions:
in response to receiving the first transaction request message, determining that the issuer system issued a corresponding first payment device based on transaction data contained in the first transaction request message;
determining an accumulated authorization amount based on preceding transaction amounts of the plurality of first transactions that have been authorized and the corresponding first transaction amount;
determining that the accumulated authorization amount does not satisfy a threshold based on the prefunded amount; and
in response to determining that the accumulated authorization amount does not satisfy the threshold, generating and communicating an authorization request message associated with the corresponding first transaction to the issuer system;
receiving, from a second merchant system, a second transaction request message associated with a second transaction initiated by a second payment device of the plurality of payment devices issued by the issuer system, the second transaction having an associated second transaction amount;
in response to receiving the second transaction request message, determining that the issuer system issued the second payment device based on transaction data contained in the second transaction request message;
determining an updated accumulated authorization amount based on the accumulated authorization amount and the second transaction amount;
determining that the updated accumulated authorization amount satisfies the threshold; and
in response to determining that the updated accumulated authorization amount satisfies the threshold, automatically declining the second transaction.

18. The computer program product of claim 17, wherein the transaction processing system is configured to transfer funds from the prefunded account, but the issuer system is not configured to transfer funds from the prefunded account.

19. The computer program product of claim 17, wherein the issuer system transfers additional funds to the prefunded account, the instructions cause the at least one processor to:
in response to the issuer system transferring the additional funds to the prefunded account, update a balance in the prefunded account based on the additional funds.

20. The computer program product of claim 19, the instructions cause the at least one processor to:
receive a webhook notification in response to the issuer system transferring the additional funds to the prefunded account.
